(19) United States
(12) Patent Application Publication
(10) Pub. No.: US 2011/0133129 A1
(43) Pub. Date: Jun. 9, 2011

(54) METHOD OF TUNING PROPERTIES OF THIN FILMS

(75) Inventors: Makoto MURAKAMI, Ann Arbor, MI (US); Zhendong HU, Ann Arbor, MI (US); Bing LIU, Ann Arbor, MI (US)

(73) Assignee: IMRA America, Inc., Ann Arbor, MI (US)

(21) Appl. No.: 12/958,105

(22) Filed: Dec. 1, 2010

Related U.S. Application Data
(60) Provisional application No. 61/267,153, filed on Dec. 7, 2009.

(51) Int. Cl. H01B 1/00; C23C 26/00; H05H 1/24; B05C 11/00

(52) U.S. Cl. 252/500; 427/596; 427/597; 427/569; 118/706

(57) ABSTRACT

A method of tuning thin film properties using pulsed laser deposition (PLD) by tuning laser parameters is provided. Various embodiments may be utilized to tune magnetic properties, conductivity or other physical properties. Some embodiments may improve performance of electrochemical devices, for example a thin film electrode may be fabricated resulting in improved reaction speed of a Li ion battery. By way of example, a material property of thin film is tuned by setting a pulse duration. In some embodiments the numbers of laser pulses and laser pulse energy are other laser parameters which may be utilized to tune the film properties. The materials that can be synthesized using various embodiments of the invention include, but are not limited to, metals and metal oxides.

### CROSS REFERENCE TO RELATED APPLICATIONS

This application claims priority to U.S. Patent Application Ser. No. 61/267,153, filed Dec. 7, 2009, entitled “A method of tuning properties of thin films”, which is hereby incorporated by reference in its entirety.

This application is related to U.S. patent application Ser. No. 12/401,967, entitled “A Method for Fabricating Thin Films”, which claims priority to Application No. 61/039,883, filed Mar. 27, 2008. This application is also related to U.S. patent application Ser. No. 12/254,076, entitled “A Method for Fabricating Thin Films”, filed Oct. 20, 2008, which claims priority to Application No. 61/039,883, filed Mar. 27, 2008. The '967 application is published as U.S. Patent Application Pub. No. 2009/0246530. The '076 application is published as U.S. Patent Application Pub. No. 2009/0246413.

This application is also related to U.S. patent application Ser. No. 11/798,114, entitled “Method for Depositing Crystalline Titania Nanoparticles and Films”, filed May 10, 2007, now published as U.S. Patent Application Pub. No. 2008/0187684.

The disclosures of application Nos. 61/039,883, 11/798,114, 12/254,076 and 12/401,967 are hereby incorporated by reference in their entirety.

### FIELD OF THE INVENTION

This invention relates to pulsed laser deposition of thin films to tune their properties.

### BACKGROUND

Pulsed laser deposition (PLD) has been used as a fabrication technique to grow nano-particles, nano-rods, nano-wires, and thin films. Ablation mechanisms in PLD are complicated and not yet fully understood. Film quality can be controlled by changing the laser fluence and/or repetition rate, growth substrate temperature, and/or background gas pressure in a vacuum chamber. Tunability of the thin films is limited by at least those parameters.

### SUMMARY OF THE INVENTION

Tunability of thin film properties is desirable for many applications of PLD. Various embodiments provide tunability of thin film properties by setting one or more laser temporal pulse parameters for thin film growth, for example a pulse duration.

In at least one embodiment a distinct and controlled change in a thin film property occurs as a function of pulse duration, for example by setting a pulse duration to a value in the range from about 20 ps to 200 ps.

In some embodiments various thin film properties can be tuned by setting a pulse duration to less than about 20 ps.

In some embodiments a combination of burst-mode operation and laser pulse duration control may be utilized for tuning the thin film properties. Burst-mode operation and examples are disclosed in U.S. patent application Ser. No. 12/401,967, entitled “A Method for Fabricating Thin Films”.

In some embodiments other laser parameters may be further utilized to tune thin film properties, for example laser pulse energy.

At least one embodiment provides a method to obtain desired magnetic properties with control of particle size, crystallinity, and/or thin film morphology.

In at least one embodiment the conductivity and/or resistivity of a film may be tuned with control of particle size, crystallinity, and/or thin film morphology.

In at least one embodiment a material property of a thin film electrode may be tuned to improve performance of an electrochemical device, for example to improve the reaction speed of a Li ion battery.

A material property may include one of more of a physical property and chemical property, and may comprise an optical and/or electrical property.

At least one embodiment provides a method to grow desired thin films. Thin film properties are tuned by controlling particle size and thin film morphology.

At least one embodiment provides for tuning crystallinity of nanoparticles and the thin films.

In some embodiments a laser pulse duration may be set in the range of about 100 fs to 50 ns to tune a thin film property.

In some embodiments pulse duration may be the range from about 10 fs to 200 ns, 100 fs-1 ns.

In some embodiments a pulse duration may be set in the range from about 1 ps to 200 ps, or from about 1 ps to 50 ps.

In some embodiments a pulse duration may be set to a value in the range from about 20 ps to 200 ps.

Various embodiments may be utilized for growth of thin films, wherein the film includes one or more properties which can be tuned as a function of laser parameter(s).

Various embodiments can be applied for control of thin film properties for magnetic materials design.

In at least one embodiment a PLD system for tuning a material property is provided. The system includes a pulsed laser and components for adjusting and/or selecting output pulse widths in at least a portion of the picosecond-nanosecond regime, and/or for providing pulse repetition rates in at least a portion of the range from about 1 MHz to about 1 GHz.

### BRIEF DESCRIPTION OF THE DRAWINGS

FIGS. 1A-1C schematically illustrates a pulsed laser system and some examples of laser parameters useful for tuning thin film properties. FIG. 1A schematically illustrates a fiber-based chirped pulse amplification (FCPA) system. By way of example, FIG. 1B illustrates pulse amplification and selection to produce a series of output pulses. FIG. 1C illustrates an example corresponding to a burst-mode operation, wherein temporal separation between pulses may correspond to frequencies in the MHz to GHZ regime.

FIG. 2 schematically illustrates an adjustable pulse compressor for varying a pulse duration. The compressor may be configured in a chirped pulse amplification system of FIG. 1A.

FIG. 3 schematically illustrates several components of a pulsed laser deposition system.

FIG. 4 illustrate scanning electron microscope (SEM) images of Ni₃Fe film surfaces.

FIG. 5 is a plot illustrating magnetic hysteresis curves of Ni₃Fe thin films, and their coercive field as a function of the number of burst pulses and the pulse duration.

FIG. 6 illustrates SEM images of TiO₂ thin films.

FIG. 7 is a plot illustrating XRD spectra of Nb:TiO₂ thin films grown on SrTiO₃ substrate.

FIG. 8 illustrates shows LiMn₂O₄ thin films and corresponding surface SEM images.

FIG. 9 is a plot illustrating voltage dependence on sweeping rate for electrochemical electrode performance testing of LiMn₂O₄ thin films.

FIG. 10 is a plot illustrating measured current voltage values obtained with testing the films of FIG. 9. The electrical potential difference, ΔE, corresponding to peak currents was used to form the plot of the FIG.

### DETAILED DESCRIPTION

The quality of thin films produced with PLD varies with lasers used and their associated parameters. For example, improved crystalline GaN phase using femtosecond pulsed laser deposition was disclosed in X. L. Tong et al., “Comparison between GaN thin film grown by femtosecond and nanosecond pulsed laser depositions” J. Vac. Sci. Technol. B, Vol. 26, (2008) 1398-1403. PLD configurations producing pulses in the range from femtoseconds to picoseconds are known, for example as disclosed in U.S. Pat. Nos. 5,432,151, 6,372,103 and U.S. Patent Application Pub. No. 20080187684. Tunability of magnetic thin films, among other things, was disclosed in Reilly et al., “Pulsed laser deposition with a high average power free electron laser: Benefits of subpicosecond pulses with high repetition rate”, Journal of Applied Physics, Vol. 93, 3098, 2003. In Reilly et al. results obtained with a free electron and Ti:sapphire laser were compared. The sensitivity of coercivity to laser parameters was identified as a point of interest. Effects of pulse energy and repetition rate of laser pulses, and in particular a high repetition rate, was studied. In Reilly et al. a combination of laser parameters, including sub-picosecond pulses, were investigated.

Applicants discovered that thin film properties may be tuned by setting pulse widths in the picosecond regime. It was also found that films properties may be further controlled with a combination of burst-mode operation and laser pulse duration control. In least one embodiment a method to tune thin films properties by controlling laser parameters is provided, particularly with control of at least the pulse duration. In various embodiments the number of pulses provides additional control. Surprising results disclosed herein show that pulse duration and other temporal parameters may be utilized to tune magnetic properties.

In various embodiments the tunability of the thin film properties is achieved by setting laser parameters such as pulse duration, the number of burst laser pulses, and/or the pulse energy. Such embodiments are particularly desirable for PLD on heat sensitive substrates, for example an organic film.

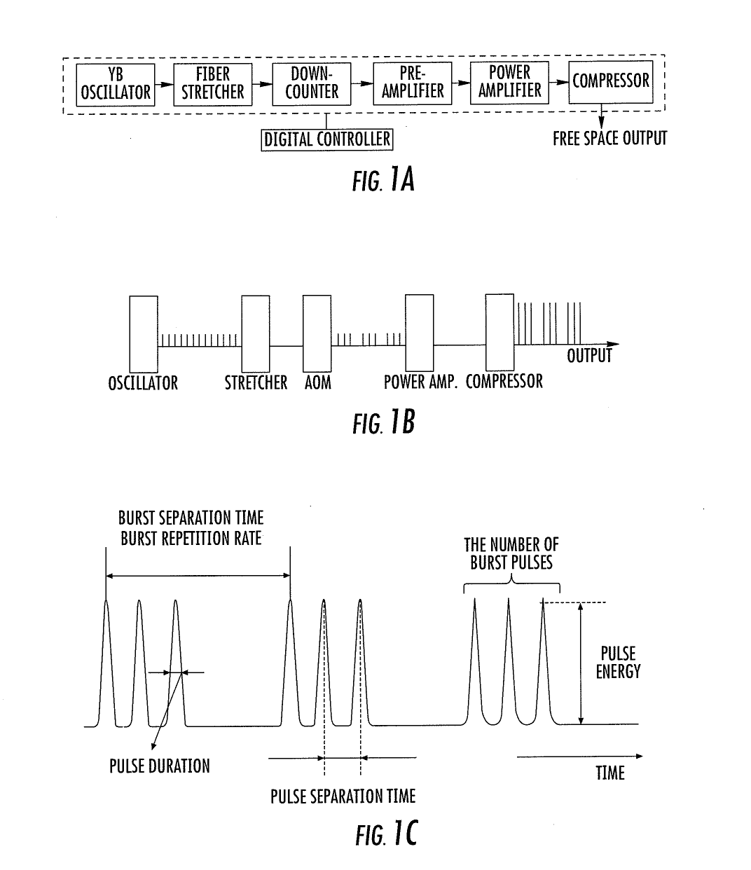

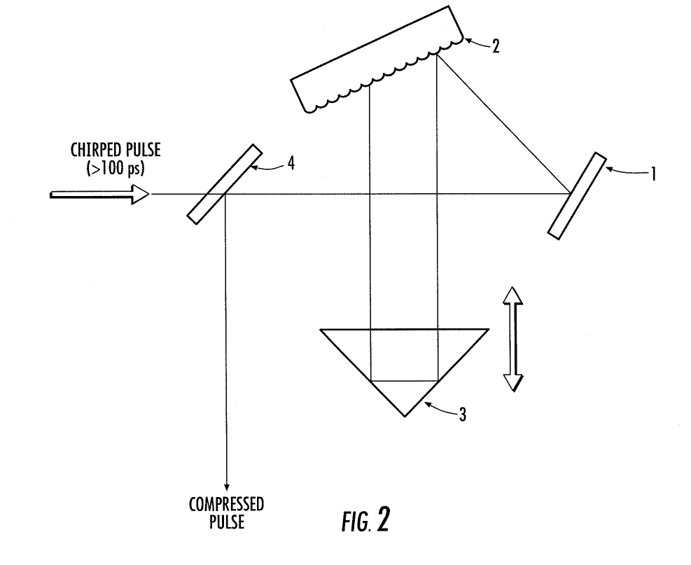

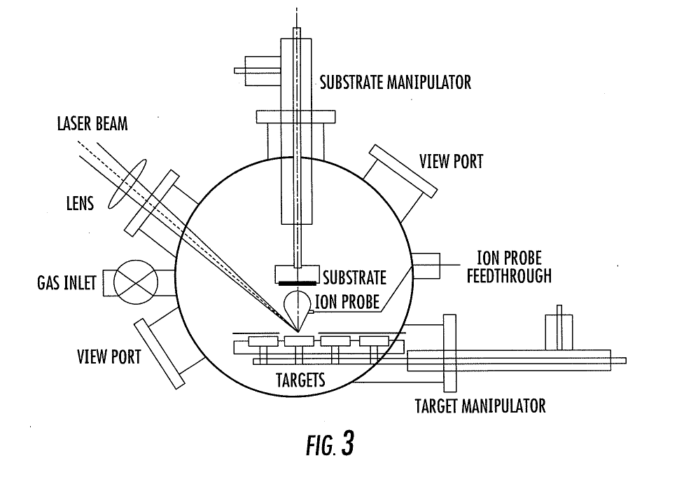

In accordance with an embodiment, FIG. 1A schematically illustrates a pulsed laser system. In this example a fiber-based chirped pulse amplification system (FCPA) is shown which generates sub-picosecond output pulses. FIG. 1B shows generation of output pulses. In this example a mode locked oscillator operates at high repetition rate, for example at 50 MHz or greater. Pulses from the mode locked source are temporally stretched prior to amplification with the power amplifier. Selection of one or more pulses is carried out with the AOM, or other suitable pulse picker, to generate output pulses and to control the effective output pulse repetition rate.

FIG. 1C shows a laser pulse train and some laser parameters for pulsed laser deposition to tune thin film properties. In this example, laser parameters are pulse duration, burst repetition rate, pulse separation time, number of burst pulses, and pulse energy. Results discussed below show tuning thin film properties can be achieved by varying pulse duration. Setting the number of pulses and/or the pulse energy provides for further control of the thin film property. In various embodiments an output may be a burst of pulses, with a pulse temporal spacing corresponding to a frequency in the range from about 1 MHz to about 1 GHz. In some embodiments the system may provide outputs in the range of 1 KHz to several hundred KHz. Setting the pulse separation time and the repetition rate provides for further control. Many possibilities exist.

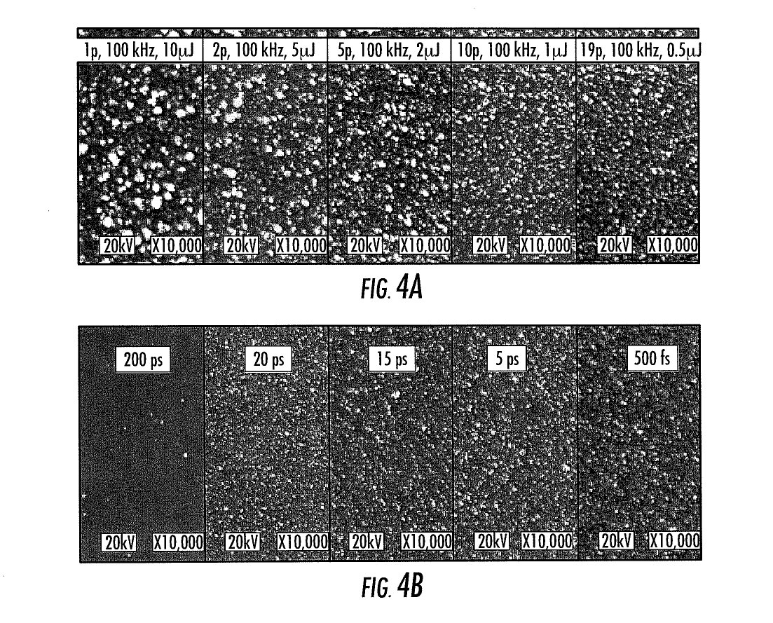

FIG. 2 schematically illustrates an adjustable pulsed compressor, which provides for adjustment of pulse duration, and may be configured in a chirped pulse amplification system. With this arrangement continuous adjustment of the pulse duration from sub picosecond to about 200 picosecond can be achieved by changing optical path length in the compressor of a chirped pulse amplification system, for example the fiber based system of FIG. 1A. By shortening the optical path by changing position of the roof shape mirror in the compressor part, the pulse duration is increased almost linearly by the distance. Additionally, by bypassing the beam before the compressor part, the beam without pulse compression can be obtained from the laser. A pulse duration may be set to a value in the range from about 500 fs to 200 ps.

In some embodiments other suitable techniques for varying a pulse duration may be utilized. For example, a combination of a laser diode and pulse modulator may be used to as an input source to generate pulses of different width, under computer control. By way of example, published U.S. Patent Application Pub. No. 2007/0053391, entitled “Laser Pulse Generator”, illustrates operation with a laser diode and modulator. The pulses may then be amplified with a fiber amplifier as illustrated in FIG. 1A. A PLD system may include elements for adjusting the pulse duration as set forth above, and components to set other temporal parameters, as well as the pulse energy. In some embodiments elements of a commercially available fiber based chirped pulse amplification system may be utilized, with suitable modifications for setting a pulse width in the picoseconds-nanosecond regime.

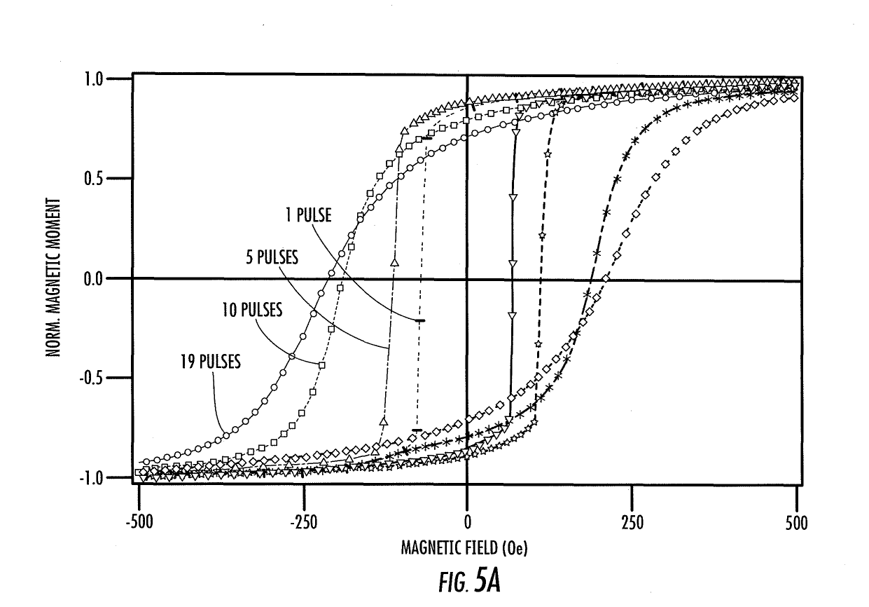

FIG. 3 schematically illustrates several additional elements of a pulsed laser deposition system, and an experimental arrangement used to carry out the experiments disclosed herein. The PLD system includes a vacuum chamber (and related pumps, not shown in the figure), a target manipulator, an ion probe (Langmuir probe), a gas inlet, and a substrate manipulator. The laser beam is focused onto the target surface through a fused silica window. The system includes a vacuum chamber pumped by a turbo pump and a mechanical pump, a target manipulator which provides rotational and lateral movements for four targets of different materials, a substrate manipulator which provides heating and rotational and lateral movements for the substrate, a gas inlet through which reactive gases are provided and their pressures are appropriately adjusted, and an ion probe (Langmuir probe) to measure the ion current of the ablation plume, which can also be used as an indicator for adjusting the focusing of the laser beam on the target surface. In some embodiments the laser beam may be scanned using a Galvanometer based scanning system (not shown). The direction of laser scanning may be perpendicular to lateral movement of the target. When measuring the ion current, the ion probe is biased from −50 to 50 V relative to the ground to collect the positive ions and electrons in the plume.

A PLD system was used to tune thin film properties: magnetic properties (coercivity), and for control of thin film morphology of metal and metal oxide thin films.

At least one embodiment provides a method to obtain desired magnetic properties, and to tune magnetic properties with control of particle size, crystallinity, and thin film morphology. In previous work magnetic metal thin films have been grown using thermal and e-beam evaporation, and magneto-sputtering. The magnetic properties can be controlled by deposition rate, power of the source etc, but most effectively by changing growth temperature. Tuning magnetic properties of the thin films without temperature control has been limited. Providing tunability of the thin film properties is a desirable advancement. The following results demonstrated new capability for tuning magnetic properties, and other physical properties.

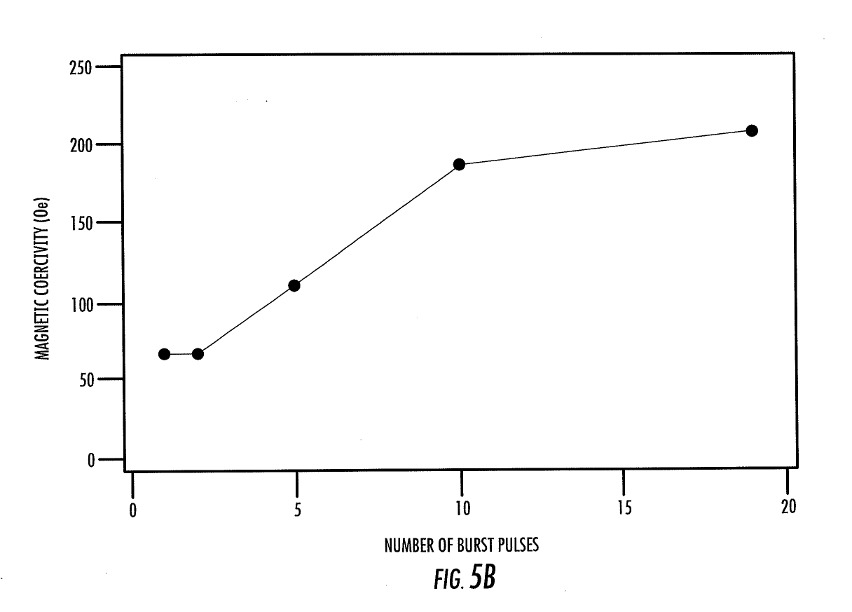

FIG. 4 illustrate scanning electron microscope (SEM) images of Ni₃Fe thin film surface collected on Si (001) substrate. FIG. 4A illustrate dependence of the number of burst pulses. FIG. 4 B shows dependence of pulse duration for the thin film growth. Laser parameters shown in the inset of FIG. 4A are: burst frequency—100 kHz, average laser power—1 W, pulse duration—0.5 picosecond, and the number of burst pulses (pulses per burst) from left to right are 1, 2, 5, 10 and 19, respectively. Laser parameters shown in the inset of FIG. 4B are: burst frequency—100 kHz, the number of burst pulses—10, and pulse durations 200, 20, 15, 5 and 0.5 picosecond, respectively. In the example of FIG. 4, the temporal spacing between consecutive pulses of a burst was set at about 20 ns, corresponding to a pulse repetition rate of about 50 MHz. Burst mode operation with temporal pulse spacing in the range of about 10 ns to 100 ns may also be utilized, and suitable pulse spacing(s) may generally correspond to operation at about 1 MHz or higher pulse repetition rates. The results show the particle size of the thin films decreases by increasing the number of the burst pulses as shown in FIG. 4A.

As shown in FIG. 4B, the particle size of the thin films does not change as a function of pulse duration in the range from 500 fs to 20 ps. It is interesting that this regime is toward the upper edge of the ultrashort and toward the lower end of the “thermal processing” regimes.

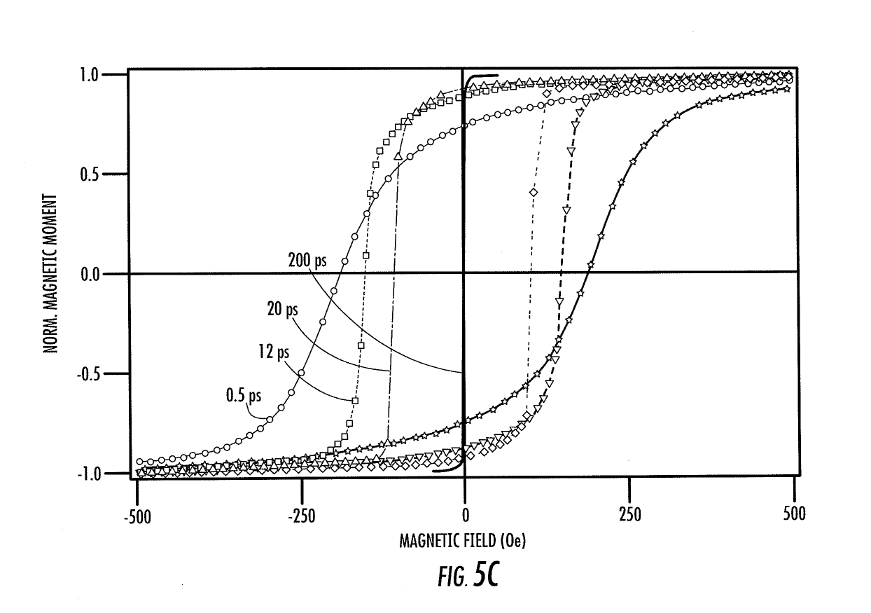

In a further experiment, magnetic properties of samples were measured. FIG. 5 illustrate magnetic hysteresis curves of Ni₃Fe thin films, and the corresponding coercive field, as a function of the number of burst pulses and the pulse duration. The magnetization is normalized to compare coercivity of the thin films. FIG. 5A illustrates the dependence on the number of burst pulses, and four hysteresis curves corresponding to 19, 10, 5, and 1 pulse(s) per burst, respectively. FIG. 5B shows plots of the coercive field as a function of the number of burst pulses. FIG. 5C illustrates the dependence on the pulse duration, and four hysteresis curves corresponding to pulse durations of 0.5, 12, 20 and 200 picoseconds, respectively. FIG. 5D shows a plot of the coercive field as a function of the pulse duration. A coercivity change of approximately 2:1 is observed over the range of pulse durations from 0.5 ps to 20 ps.

In the example of FIG. 5, the temporal spacing between consecutive pulses of a burst was again set at about 20 ns, corresponding to a pulse repetition rate of about 50 MHz. In FIGS. 5C and 5D, the number of burst pulses was set to 10.

The results show that magnetic coercivity is increased by increasing the number of burst pulses as shown in FIGS. 5A and 5B. A striking decrease in magnetic coercivity was observed with increasing laser pulse duration for the ablation of the thin films. The inventors also found that the magnetic hysteresis curve of a Ni₃Fe thin film which was fabricated using a nanosecond laser (16 nanosecond and 16 kHz) showed almost the same coercivity (2 Oe) as the thin films using 200 ps pulse duration. The results indicate that magnetic properties of the thin films are tunable by the laser pulse duration (at least up to about 200 ps) and the number of burst pulses for the thin film ablation. In other experiments the inventors confirmed that cobalt thin films also show same general trend as observed with Ni₃Fe thin films.

The dependency of coercivity of magnetic metals upon ablation pulse width, as discovered with the examples of Ni₃Fe and Co thin films, is not expected to change beyond about 200 ps, and particularly in the ns regime. Therefore, the tunability in such large pulse width ranges (ns and greater) is insubstantial.

The results obtained with picosecond operation for tunability of magnetic properties were surprising. It is known that picosecond pulsed laser processing of several types of materials can exhibit thermal behavior (e.g.: melt formation), even in the range of a few tens of picoseconds and higher. Ultrashort pulse widths, for example below about 10 ps, are therefore preferred for various precision micro-machining applications, and are generally desirable for many PLD applications also. Pulsed laser deposition using nanosecond lasers has not been regarded as a suitable method to grow magnetic metal thin films because of the known droplet generation problems caused by thermal ablation processes.

The tunability of magnetic properties is desirable for the design of device applications based on magnetic materials. If the magnetic properties are precisely controlled the design of the devices may be simplified and potentially provide for new devices based on these magnetic materials.

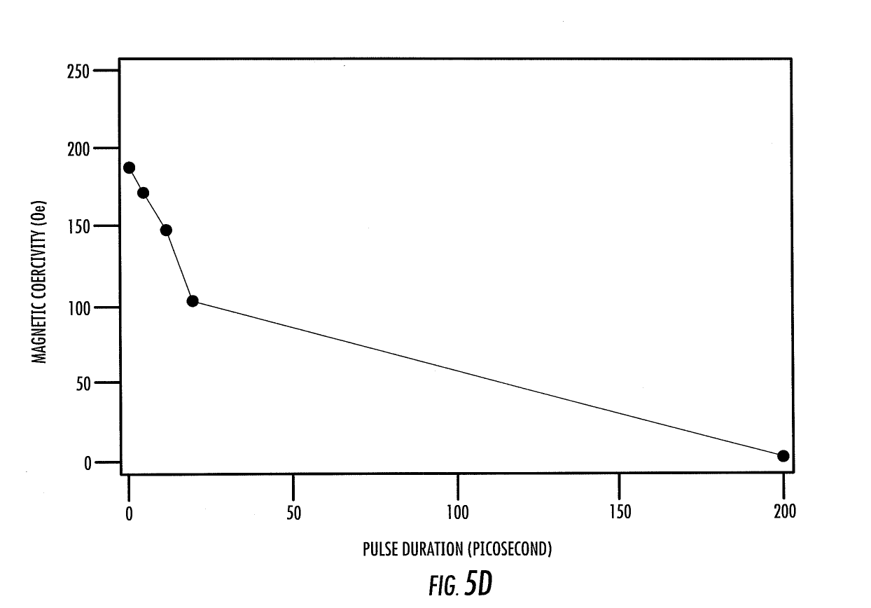

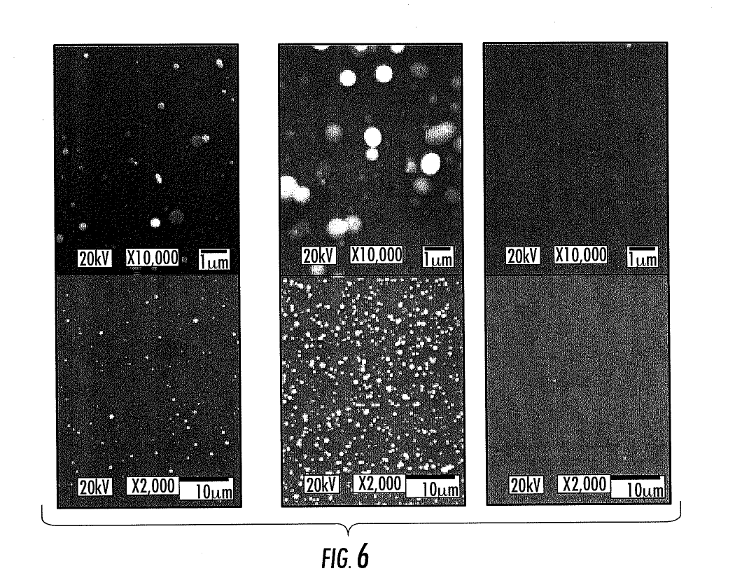

FIG. 6 illustrates SEM images of TiO₂ thin films. FIG. 6A, B, C illustrate the dependence of morphology on the pulse duration. In this example the pulse durations are 0.5, 20, and 200 picoseconds from FIG. 6A on the left to FIG. 6C on the right, respectively. Two magnifications (at top and bottom of each FIG) illustrate the morphology at 2000× and 10000×. All the thin films were grown at room temperature and the oxygen pressure is set to 1×10⁻² mbar during the growth. In this example, and in contrast to the examples above, single pulses were produced at 1 MHz (1 μsec pulse temporal spacing). As seen in the figures, the thin film morphology was tuned substantially by the pulse duration at 200 ps. It is evident that the films are nearly particle free down to the sub-μm particle level. Thus, significant thin film morphology changes are observed by increasing the laser pulse duration from 20 ps to 200 ps.

Smooth TiO₂ thin films were also obtained using burst-mode pulses with 200 ps pulse duration (not shown). The results were comparable to those illustrated in FIG. 6, and nearly particle free films were obtainable as described in Applicants U.S. patent application Ser. No. 12/401,967, which is incorporated by reference in its entirety. An observed benefit of pulse duration for TiO₂ thin film growth includes smooth thin films, without significant droplets. Sub-μm sized clusters may be obtained using higher pulse energy and high deposition rate. Cobalt (ferromagnet) and Mn (antiferromagnet) thin film morphologies are also tunable, with the approximate same trend as seen for Ni₃Fe and TiO₂ thin films.

At least one embodiment provides for tuning the crystallinity of nanoparticles and the thin films. The crystallinity can be tuned by setting the pulse duration, the number of burst-mode pulses, and the pulse energy. In some embodiments, growth may be carried out at room temperature. Further crystallinity tuning can be achieved by controlling growth temperature, as an optional parameter.

FIG. 7 illustrates XRD spectra of Nb:TiO₂ thin films grown on SrTiO₃ substrate. In this example, TiO₂ thin films were grown with conditions as shown in the left column of table 1. The left column shows the number of pulses in a burst, repetition rate of the burst, pulse energy, and oxygen partial pressure in the vacuum chamber. Separation time between pulses in the burst was about 20 ns. Pulse duration was about 1 picosecond for these experiments. The substrate temperature during the growth was 700° C. and 1×10⁻⁴ mbar. The XRD result revealed that by increasing the number of burst pulses for the ablation higher diffraction peak intensity is clearly observed. Thus, the results indicate that Nb:TiO₂ thin films of greater crystallinity are being grown since the thickness of the films are about same.

In some embodiments conductivity may be tuned. The conductivity depends on several parameters, such as number of defects in the materials, and the crystallinity of the materials. Conductivity control of the thin films has been achieved by optimizing growth conditions such as substrate temperature and processing gas pressure. Conductivity control of thin films with control of laser parameters can be beneficial when the films must be grown under heat sensitive conditions, such as on a polymer substrate.

Experiments were carried out to investigate tuning of conductive properties. Table 1 below illustrates measurements of thickness (Å), resistance by using a 4 probe multi meter (kΩ), resistivity (Ωcm), electron mobility, and carrier density (cm⁻³) of the corresponding thin films shown in FIG. 7. The left column shows the number of pulses in a burst, repetition rate of the burst, pulse energy, and oxygen partial pressure in the vacuum chamber. The substrate temperature was fixed at 700° C. during the growth. As above, separation time between pulses in the burst was about 20 ns. Pulse duration was about 1 picosecond for these experiments. Missing data points in the table correspond to results where the resistance of the film was too high for the measurement instrument. The results were confirmed by Hall measurements with sample size of 10×10 mm². An increase in the resistance and the resistivity and decrease in the mobility and the carrier density were observed by decreasing the number of burst pulses for the ablation.

TABLE 1

| | | | | | | Resistance (4 | Resisitivity | | Carier density |
|---|---|---|---|---|---|---|---|---|---|
| | | | | | Thickness | probe) KOhm | (ohm · cm) | Mobility | (cm⁻³) |
| 2 p | 1 | MHz | 200 nJ | 1 × 10⁻⁴ mbar | 1512 | 3240 | — | — | — |
| 16 p | 125 | kHz | 200 nJ | 1 × 10⁻⁴ mbar | 1479 | 142 | 10 | 2.10E−01 | 3.00E+18 |
| 19 p | 1 | MHz | 50 nJ | 1 × 10⁻⁴ mbar | 1500 | 0.049 | 1.70E−03 | 9.5 | 3.90E+20 |

The results of FIG. 7 and Table 1 reveal that the electric properties of crystallinity, resistivity, mobility, and carrier density of the conductive materials are controllable by the laser parameters. In this example, we illustrated that the thin film properties are tunable by setting the number of laser pulses in each burst used (e.g.: 2, 16, and 19 pulses in this example).

In various embodiments properties of electro-chemical devices, or portions thereof, may be tuned by varying temporal parameters of one or more pulses. To advance thin film battery technology, embodiments providing for growth of electrode thin films with tunable size and morphology in a vacuum chamber can produce several benefits. For instance, during fabrication of the thin film batteries, exposure to air can create undesired structure or material created by such as oxidation by air or moisture during the exposure. Moreover, performance control of the electrode materials for the electrode by adjusting laser parameters can be useful when heat sensitive materials are used for the battery structure (such as in the solid electrolyte and the substrate).

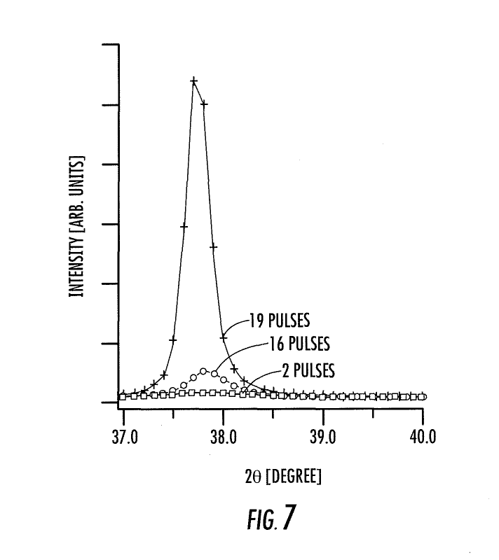

FIG. 8 illustrate photos and the surface SEM images of LiMn₂O₄ thin films fabricated on Pt foil. LiMn₂O₄ is a well known cathode material for lithium ion batteries. In this example LiMn₂O₄ thin films were grown with 2, 4, 8, and 19 pulses (number of pulses in a burst) at 100 kHz burst frequency, and 19 pulses at 1 MHz, respectively. Separation time between pulses in the burst was about 20 ns. Pulse duration was about 1 picosecond for these experiments. Oxygen partial pressure of about 1×10⁻² mbar and a substrate temperature 300 deg. C. were set for these experiments. This example illustrates a similar trend to that discussed above. For example, the thin film morphology gets smoother by increasing the number of burst pulses.

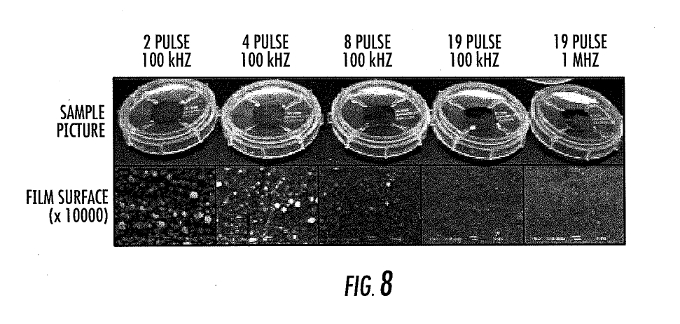

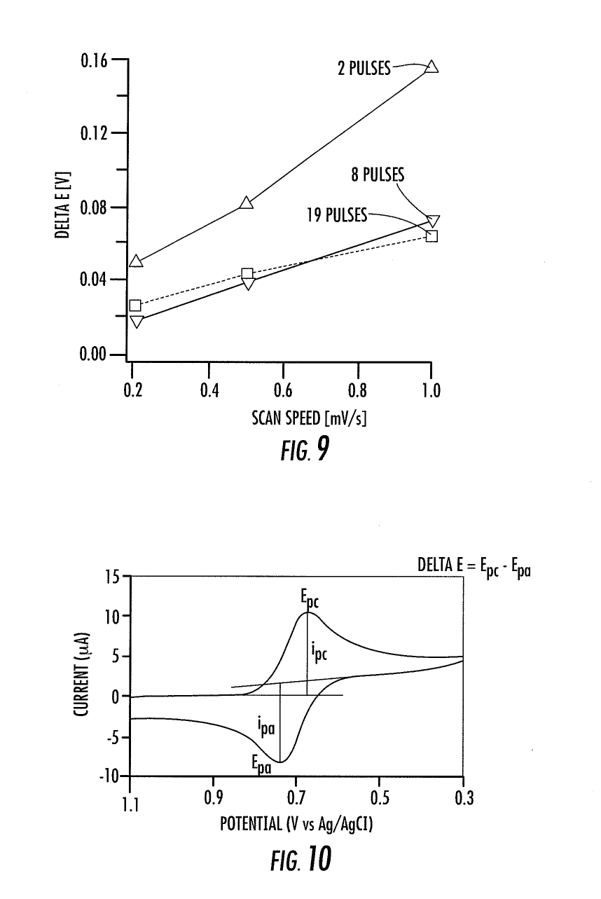

FIG. 9 illustrates ΔE voltage dependence on sweeping rate (V/s) for electrochemical electrode performance test of LiMn₂O₄ thin films. Referring to FIG. 10, ΔE is defined by the peak current for the measurements, and further defined by corresponding electrical potential values along the horizontal axis. In this example, the films were grown on about 10×10 mm² Pt foil using 2, 8, and 19 pulses with 100 kHz burst repetition rate as mentioned above. The films are annealed in tube furnace at 600° C. for 2 hours before the measurements. The capacitance of each thin film was set approximately equal for this example. Smaller ΔE implies that the reaction speed of the electrode is faster. The results show that the reaction speed of the thin films increases by increasing the number of burst pulses for the thin film growth.

At least one embodiment provides a method to grow desired thin films and tune their properties by controlling particle size and thin film morphology. When the particle size and density (particles/area) change, the surface morphology of the thin films is also changed. As a result, by controlling particle size and thin film morphology, the thin film properties are modified.

FIG. 1C illustrates several pulse parameters which, alone or in combination, may be adjusted to tune a thin film material property. The above examples illustrate that pulse duration and/or number of pulses in a high repetition rate burst may provide for tunability. Other temporal parameters may include pulse power/energy, pulse repetition rate, and/or burst rate. In some embodiments laser pulse duration may be in a range of about 100 fs to 50 ns, more preferably 1 ps to 200 ps, and most preferably 20 ps to 200 ps. Exemplary pulse energy may be in the range of about 1 nJ to 10 mJ, or within similar ranges, and may be in the range of 10 nJ to 10 μJ. By way of example, the number of pulses per burst may be set in the range from a single pulse to about 5, 10, 20, 50, 100 or 500 pulses utilizing a pulsed laser system as discussed above. In various embodiments a pulse repetition rate may be in the range from about 100 kHz-100 MHz, or more preferably in the range from about 1 MHz to 100 MHz. A burst repetition rate may be in the range from about 1 KHz up to about 5 MHz.

In the PLD experiments discussed above processing was carried out with a spot size of about 30 μm. Thus, a pulse may provide a minimum fluence of about 10⁻⁴ J/cm² with pulse energy of about 1 nJ. If pulse energy of 1 μJ is applied to the target material the fluence will be increased to about 0.1 J/cm². In various embodiments a laser spot size may be in the range from about a few microns to a few hundred microns. In various embodiments a PLD system includes optical elements for delivering the laser beam such that the beam is focused onto the target surface with an appropriate average energy density and an appropriate energy density distribution.

In summary, materials used for the above examples were Ni₃Fe (permalloy), cobalt, and manganese for magnetic applications. TiO₂ samples were grown with both pulse duration and burst-mode operation to demonstrate tuning of film morphology. Additionally Nb:TiO₂ samples were grown with conductivity, crystallinity, and morphology control. LiMn₂O₄ samples were processed with burst-mode, and the results show such processing may be utilized for lithium ion battery fabrication. Substrates used for above examples were Si, glass, SrTiO₃, and Pt foil. In various embodiments other targets and substrates may be utilized for thin film growth.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all such changes and modifications as fall within the spirit and scope of the invention, as defined by the appended claims, and equivalents thereof.

We claim:

1. A laser-based method of tuning a material property of a thin film, comprising:
setting a temporal parameter of one of more laser pulses, said temporal parameter comprising at least one of a pulse duration and a number of pulses within a time interval;
ablating a target material with said one or more pulses;
depositing ablated target material on a substrate to form a thin film, wherein a material property of said thin film is characterizable by a distinct and controlled change in said material property of as a function of said temporal parameter.

2. The method of claim 1, wherein said laser pulses form a burst, and said temporal parameter comprises a number of pulses within a time interval less than about 1 μsec.

3. The method of claim 1, wherein said material property comprises a magnetic property, and said pulse duration is in the range from about ten picoseconds to a few tens of nanoseconds.

4. The method of claim 3, wherein the magnetic property comprises coercivity.

5. The method of claim 4, wherein setting said temporal parameter tunes said coercivity over a range from at least about 3:1 to about 100:1.

6. The method of claim 3, wherein magnetic property comprises Curie temperature.

7. The method of claim 1, wherein a thin film property comprises conductivity or resistivity.

8. The method of claim 7, wherein said conductivity or resistivity is affected by carrier density and/or mobility of the thin films.

9. The method of claim 1, wherein said method forms a thin film electrode portion of an electrochemical device.

10. The method of claim 9, wherein a relative increase in reaction speed of said electrochemical device is obtainable with tuning said material property of said thin film.

11. The method of claim 1, wherein said thin film property comprises thin film surface morphology.

12. The method of claim 1, wherein said thin film property comprises crystallinity of said thin film.

13. The method of claim 1, wherein said material property comprises one or more of a magnetic, electrical, thermal and optical property.

14. The method of claim 1, wherein said pulse duration is set in the range from about 100 fs-1 ns.

15. The method of claim 1, wherein said pulse duration is set in the range from about 20 ps to 200 ps.

16. The method of claim 1, further comprising setting a pulse energy of said one or more pulses to tune said material property.

17. The method of claim 16, wherein said pulse energy is in the range from about 1 nJ-100 uJ, and preferably in the range from about 50 nJ-10 uJ.

18. The method of claim 2, wherein said number of pulses is on the range from 1 to about 500.

19. The method of claim 2, wherein said number of pulses is in the range from 1 to about 50.

20. The method of claim 1, wherein said pulses are group of laser pulses with a pulse separation time which is shorter than 200 ns, and preferably shorter than 20 ns.

21. The method claim 1 wherein said temporal parameters comprise a pulse repetition rate.

22. The method claim 21, wherein said repetition rate is in the range from about −1 MHz to 100 MHz.

23. The method of claim 1, wherein a thin film material comprises a metal or metal oxide.

24. The method of claim 1, wherein a thin film material comprises metal nitride, arsenide, or sulfide.

25. The method of claim 1, wherein a wavelength of a pulse is in the near UV, visible, or near infrared wavelength range.

26. A laser-based method of tuning a thin film material property, comprising:
depositing materials onto substrates to form thin-films or nanoparticle aggregates by placing a substrate in the plasma stream generated by pulsed laser ablation in a vacuum chamber
tuning at least one thin film property by adjusting at least one temporal laser parameter, said at least one parameter comprising at least one of a laser pulse duration and a number of pulses within a time interval.

27. The method of claim 26, wherein said vacuum chamber is operated from atmosphere down to ultra high vacuum (˜1×10⁻¹⁰ mbar).

28. A pulsed laser deposition system for carrying out the method of claim 1, said system comprising elements for setting at least one of a pulse duration and a number of pulses within a time interval.

29. The pulsed laser deposition system of claim 28, wherein said elements comprise one or more of a pulse compressor, a combination of a laser diode and optical modulator, a gain switched laser diode, an optical switch, and a fiber amplifier.

30. A product comprising: a substrate having a thin film deposited thereon, wherein a property of said thin film material is tuned by the method of claim 1.
